(19) United States
(12) Patent Application Publication
(10) Pub. No.: US 2015/0077037 A1
(43) Pub. Date: Mar. 19, 2015

(54) WIRELESS POWER TRANSMISSION UTILIZING ALTERNATE ENERGY SOURCES

(71) Applicant: DvineWave Inc., San Ramon, CA (US)

(72) Inventors: Michael A. Leabman, San Ramon, CA (US); Gregory Scott Brewer, Livermore, CA (US)

(73) Assignee: DvineWave Inc., San Ramon, CA (US)

(21) Appl. No.: 14/026,852

(22) Filed: Sep. 13, 2013

(51) Int. Cl. H02J 7/02; H02J 17/00

(52) U.S. Cl. CPC H02J 7/025; H02J 17/00
USPC 320/101; 320/108

(57) ABSTRACT

The present disclosure describes a methodology for wireless power transmission based on pocket-forming. This methodology may include one transmitter and at least one or more receivers, being the transmitter the sender of energy and the receiver the device that is desired to charge or power. In the present disclosures, transmitters may utilize alternate sources of energy such as solar or wind power. Furthermore, transmitters, in some embodiments, may include a battery module for storing surplus energy. Lastly, a portable assembly for providing wireless power running on alternate sources of energy may be provided.

### CROSS-REFERENCES TO RELATED APPLICATIONS

The present disclosure is related to U.S. Non-Provisional patent application Ser. No. 13/891,430 filed May 10, 2013, entitled “Methodology For Pocket-forming”; Ser. No. 13/925,469 filed Jun. 24, 2013, entitled “Methodology for Multiple Pocket Forming”; Ser. No. 13/946,082 filed Jul. 19, 2013, entitled “Method for 3 Dimensional Pocket-forming”; Ser. No. 13/891,399 filed May 10, 2013, entitled “Receivers for Wireless Power Transmission” and Ser. No. 13/891,445 filed May 10, 2013, entitled “Transmitters For Wireless Power Transmission”, the entire contents of which are incorporated herein by these references.

### FIELD OF INVENTION

The present disclosure relates generally to wireless power transmission, and more particularly, to wireless power transmission utilizing alternate sources of energy.

### BACKGROUND OF THE INVENTION

Electronic devices such as laptop computers, smartphones, portable gaming devices, tablets and so forth may require power for performing their intended functions. This may require having to charge electronic equipment at least once a day, or in high-demand electronic devices more than once a day, whereby electrical costs may increase. Moreover, such an activity may be tedious and may represent a burden to users. For example, a user may be required to carry chargers in case his electronic equipment is lacking power. In addition, users have to find available power sources to connect to. Furthermore, the forgoing power sources may depend on energy sources such as hydrocarbon which may be expensive but also pollutant and harmful to the environment. There are some instances where such economic cost may turn electricity scarce.

For the foregoing reasons, there is a need for a wireless power transmission system where electronic devices may be powered without requiring extra chargers or plugs an utilizing alternate sources of energy as power sources.

### SUMMARY OF THE INVENTION

The present disclosure describes a methodology for wireless power transmission based on pocket-forming. This methodology may include one transmitter and at least one or more receivers, being the transmitter the source of energy and the receiver the device that is desired to charge or power. Techniques for determining the location of devices including receivers may be disclosed.

In an embodiment, a description of pocket-forming methodology using at least one transmitter and at least one receiver may be provided.

In another embodiment, a transmitter suitable for pocket-forming including at least two antenna elements may be provided.

In a further embodiment, a receiver suitable for pocket forming including at least one antenna element may be provided.

In an embodiment, a transmitter utilizing at least one solar panel, as power supply, for delivering power wirelessly to users waiting for transportation on train stations, bus stations or airports may be provided.

In another embodiment, a plurality of transmitters utilizing at least one solar panel, as power supply, on lamp pole structures for delivering power wirelessly to pedestrians may be provided.

In yet another embodiment, a transmitter utilizing at least one wind turbine, as power supply, for delivering power wirelessly to houses or selected regions may be provided.

In yet another further embodiment, a portable assembly including a power module for delivering wireless power in locations where electricity can be scarce may be provided.

A wireless power transmission, comprising: pocket-forming transmitter for generating power RF waves to form pockets of energy converging in 3-d space for powering or charging an electronic device; an alternative power source connected to the transmitter for powering the transmitter; and a receiver for capturing the pockets of energy to charge or power the electronic device connected to the receiver.

The disclosed configurations and methods of wireless power transmission with alternative power sources may provide efficient and simultaneous charging of one or more electronic devices, while using at least one or more transmitters that may position its antenna array in suitable locations accessible to the public for optimal pocket forming. Additional features and advantages can become apparent from the detailed descriptions which follow taken in conjunction with the accompanying drawings.

### BRIEF DESCRIPTION OF THE DRAWINGS

Embodiments of the present disclosure are described by way of example with reference to the accompanying figures which are schematic and may not be drawn to scale. Unless indicated as representing the background information, the figures represent aspects of the present disclosure.

FIG. 1 illustrates wireless power transmission using pocket-forming according to the present invention.

FIG. 2 illustrates a component level illustration for a transmitter which may be utilized to provide wireless power transmission as described in FIG. 1 according to the present invention.

FIG. 3 illustrates a component level embodiment for a receiver which can be used for powering or charging an electronic device as described in FIG. 1 according to the present invention.

FIG. 4 illustrates a wireless power transmission where a transmitter utilizing at least one solar panel, as power supply, may provide wireless power, through pocket-forming, to users wanting to charge their electronic devices at bus station, airports, train stations and the like according to the present invention.

FIG. 5 illustrates a wireless power transmission where either one or a plurality of transmitters, utilizing at least one solar panel, can be used to provide wireless power, through pocket-forming, to pedestrians wanting to charge electronic devices, according to the present invention.

FIG. 6 illustrates a wireless power transmission where a transmitter may utilize a typical wind turbine as alternative power source.

FIG. 7 illustrates a wireless power transmission where a portable assembly for delivering power may be utilized

### DETAILED DESCRIPTION OF THE DRAWINGS

### Definitions

“Pocket-forming” may refer to generating two or more RF waves which converge in 3-d space, forming controlled constructive and destructive interference patterns.

“Pockets of energy” may refer to areas or regions of space where energy or power may accumulate in the form of constructive interference patterns of RF waves.

“Null-space” may refer to areas or regions of space where pockets of energy do not form because of destructive interference patterns of RF waves.

“Transmitter” may refer to a device, including a chip which may generate two or more RF signals, at least one RF signal being phase shifted and gain adjusted with respect to other RF signals, substantially all of which pass through one or more RF antenna such that focused RF signals are directed to a target.

“Receiver” may refer to a device including at least one antenna element, at least one rectifying circuit and at least one power converter, which may utilize pockets of energy for powering, or charging an electronic device.

“Adaptive pocket-forming” may refer to dynamically adjusting pocket-forming to regulate power on one or more targeted receivers.

### DESCRIPTION OF THE DRAWINGS

In the following detailed description, reference is made to the accompanying drawings, which form a part hereof. In the drawings, which may not be to scale or to proportion, similar symbols typically identify similar components, unless context dictates otherwise. The illustrative embodiments described in the detailed description, drawings and claims, are not meant to be limiting. Other embodiments can be used and/or and other changes can be made without departing from the spirit or scope of the present disclosure.

A. Essentials of Pocket-Forming

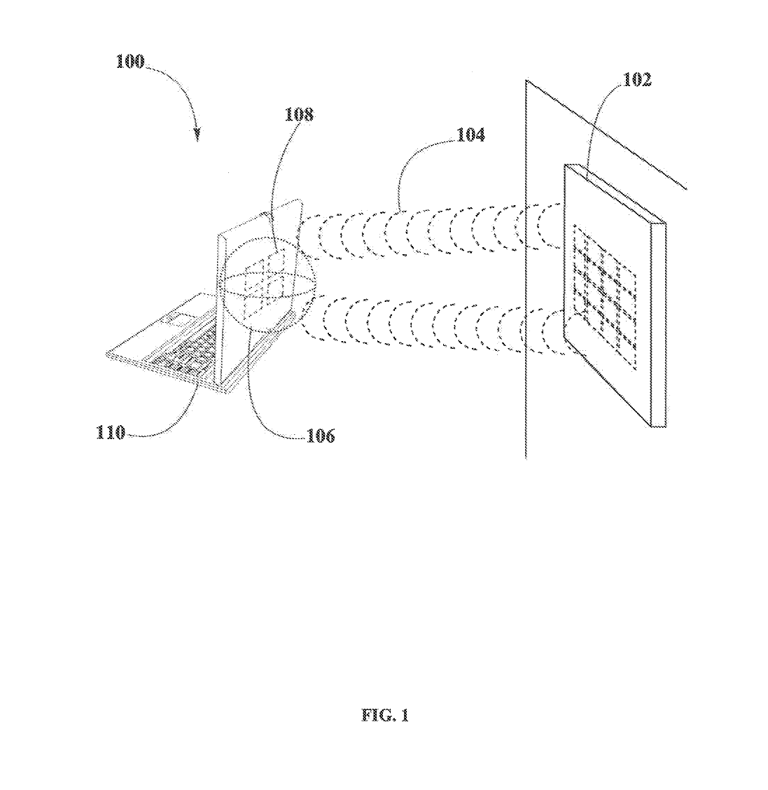

FIG. 1 illustrates wireless power transmission (WPT) 100 using pocket-forming. A transmitter 102 may transmit controlled Radio Frequency (RF) waves 104 which may converge in 3-d space. These RF waves 104 may be controlled through phase and/or relative amplitude adjustments to form constructive and destructive interference patterns (pocket-forming). Pockets of energy 106 may form at constructive interference patterns and can be 3-dimensional in shape whereas null-spaces may be generated at destructive interference patterns. A receiver 108 may then utilize pockets of energy 106 produced by pocket-forming for charging or powering an electronic device, for example a laptop computer 110 and thus effectively providing wireless power transmission. In some embodiments, there can be multiple transmitters 102 and/or multiple receivers 108 for powering various electronic devices, for example smartphones, tablets, music players, toys and others at the same time. In other embodiments, adaptive pocket-forming may be used to regulate power on electronic devices.

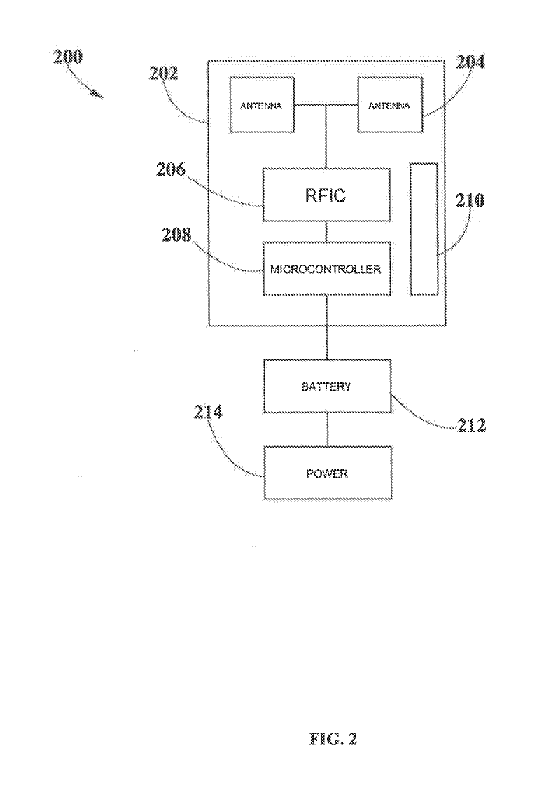

FIG. 2 illustrates a component level embodiment for a transmitter 200 which may be utilized to provide wireless power transmission 100 as described in FIG. 1. Transmitter 200 may include a housing 202 where at least two or more antenna elements 204, at least one RF integrated circuit (RFIC) 206, at least one digital signal processor (DSP) or micro-controller 208, at least one optional communications component 210 and at least one battery component 212 may be included. Housing 202 can be made of any suitable material which may allow for signal or wave transmission and/or reception, for example plastic or hard rubber. Antenna elements 204 may include suitable antenna types for operating in frequency bands such as 900 MHz, 2.5 GHz or 5.8 GHz as these frequency bands conform to Federal Communications Commission (FCC) regulations part 18 (Industrial, Scientific and Medical equipment). Antenna elements 204 may include vertical or horizontal polarization, right hand or left hand polarization, elliptical polarization, or other suitable polarizations as well as suitable polarization combinations. Suitable antenna types may include, for example, patch antennas with heights from about ⅛ inches to about 6 inch and widths from about ⅛ inches to about 6 inch. Other antenna elements 204 types can be used, for example meta-materials, dipole antennas among others. RFIC 206 may include a proprietary chip for adjusting phases and/or relative magnitudes of RF signals which may serve as inputs for antenna elements 204 for controlling pocket-forming. These RF signals may be produced using an external power supply 214 and a local oscillator chip (not shown) using a suitable piezoelectric material. Power supply 214 can be an AC or DC power source which may include suitable energies sources or devices such as combustion engines, thermal sources, wind turbines, solar panels and the like. Additionally, transmitter 200 may utilize battery component 212 to store surplus energy. Micro-controller 208 may then process information send by a receiver through its own antenna elements for determining optimum times and locations for pocket-forming. In some embodiments, the foregoing may be achieved through. communications component 210. Communications component 210 may be based on standard wireless communication protocols which may include Bluetooth, Wi-Fi or ZigBee. In addition, communications component 210 may be used to transfer other information such as an identifier for the device or user, battery level, location or other such information. Other communications component 210 may be possible which may include radar, infrared cameras or sound devices for sonic triangulation for determining the device's position.

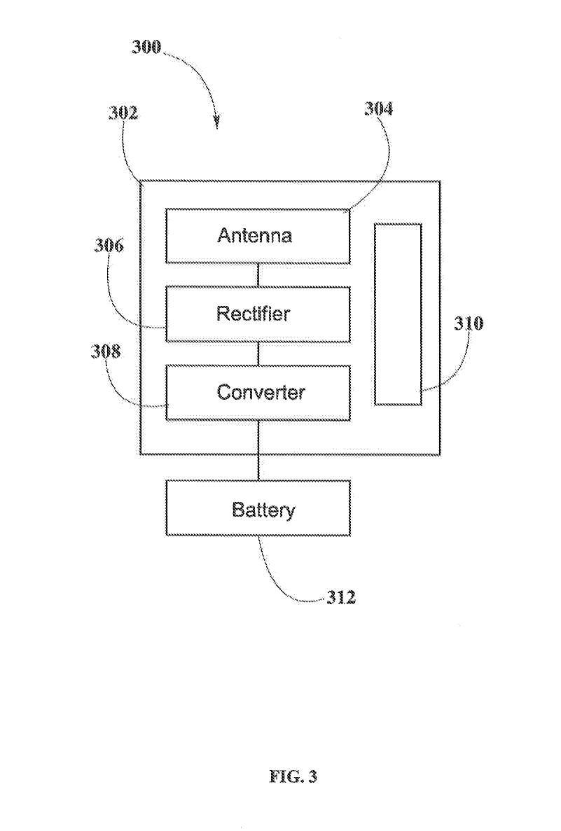

FIG. 3 illustrates a component level embodiment for a receiver 300 which can be used for powering or charging an electronic device as exemplified in wireless power transmission 100. Receiver 300 may include a housing 302 where at least one antenna element 304, one rectifier 306, one power converter 308 and an optional communications component 310 may be included. Housing 302 can be made of any suitable material which may allow for signal or wave transmission and/or reception, for example plastic or hard rubber. Housing 302 may be an external hardware that may be added to different electronic equipment, for example in the form of cases, or can be embedded within electronic equipment as well. Antenna element 304 may include suitable antenna types for operating in frequency bands similar to the bands described for transmitter 200 from FIG. 2. Antenna element 304 may include vertical or horizontal polarization, right hand or left hand polarization, elliptical polarization, or other suitable polarizations as well as suitable polarization combinations. Using multiple polarizations can be beneficial in devices where there may not be a preferred orientation during usage or whose orientation may vary continuously through time, for example a smartphone or portable gaming system. On the contrary, for devices with well-defined orientations, for example a two-handed video game controller, there might be a preferred polarization for antennas which may dictate a ratio for the number of antennas of a given polarization. Suitable antenna types may include patch antennas with heights from about ⅛ inches to about 6 inch and widths from about ⅛ inches to about 6 inch. Patch antennas may have the advantage that polarization may depend on connectivity, i.e. depending on which side the patch is fed, the polarization may change. This may further prove advantageous as a receiver, such as receiver 300, may dynamically modify its antenna polarization to optimize wireless power transmission. Rectifier 306 may include diodes or resistors, inductors or capacitors to rectify the alternating current (AC) voltage generated by antenna element 304 to direct current (DC) voltage. Rectifier 306 may be placed as close as is technically possible to antenna element 304 to minimize losses. After rectifying AC voltage, DC voltage may be regulated using power converter 308. Power converter 308 can be a DC-DC converter which may help provide a constant voltage output, regardless of input, to an electronic device, or as in this embodiment to a battery 312. Typical voltage outputs can be from about 5 volts to about 10 volts. Lastly, communications component 310, similar to that of transmitter 200 from FIG. 2, may be included in receiver 300 to communicate with a transmitter or to other electronic equipment.

B. Wireless Power Transmission Utilizing Alternate Sources of Energy

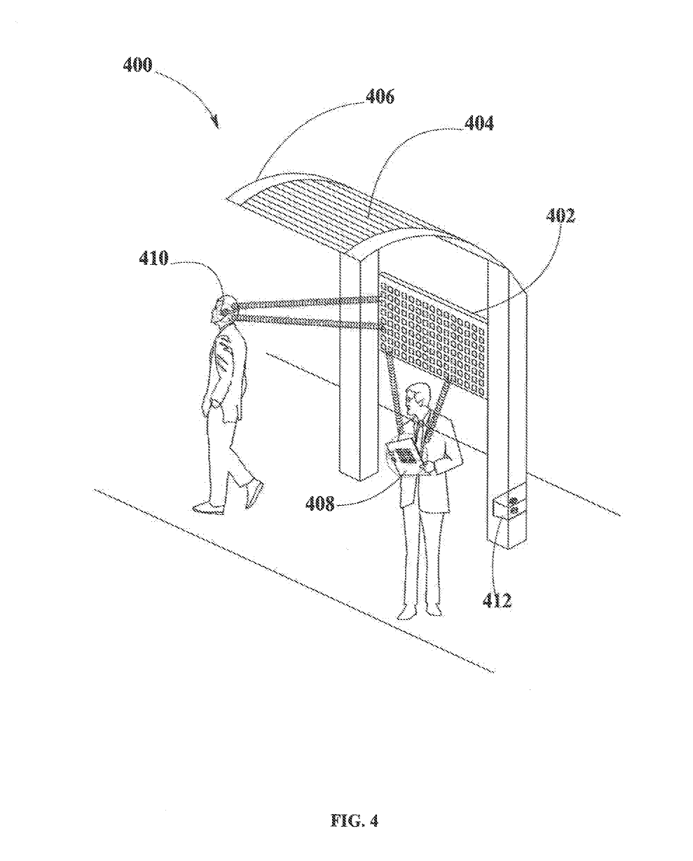

FIG. 4 illustrates a WPT 400 where a transmitter 402, similar to transmitter 200 described in FIG. 2 above, utilizes at least one solar panel 404, as power supply 214, for providing wireless power, through pocket-forming, to users wanting to charge their electronic devices. In this embodiment, a bus stop station may include solar panel 404 in its roof 406 for providing solar power to transmitter 402. Users on such a bus stop station may power their electronic devices, wirelessly through pocket forming, while waiting for transportation. In this embodiment, one user may charge a tablet 408 while another user may power a Bluetooth headset 410. Both electronic devices, i.e. tablet 408 and/or headset 410 may include receivers suitable for pocket forming (as described in FIG. 3 above). Moreover, the aforementioned bus stop station may include an energy storing unit 412 for saving surplus solar energy. Such energy storing unit 412 may function as battery component 212 for transmitter 200. WPT 400 may be beneficial because users can power devices using alternate sources of energy different from coal or fuel oils. Moreover, electronic devices can be charged while traveling without requiring any wired connections and without the inconveniences typically associated with carrying chargers. The disclosed arrangement could also be employed in train stations, airports and other such places. Furthermore, energy storing unit 412 can be used to provide power at such locations during the night, or during poor solar conditions.

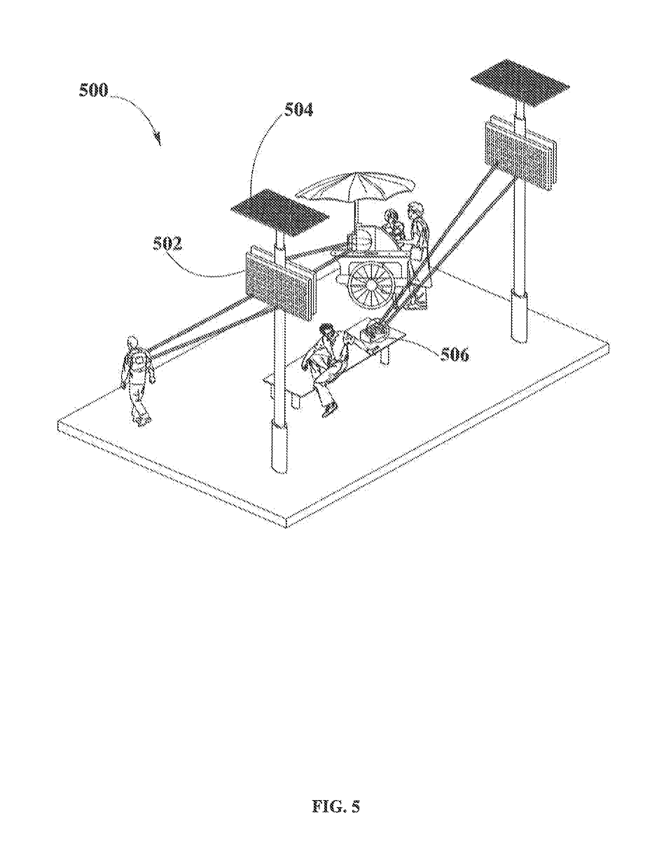

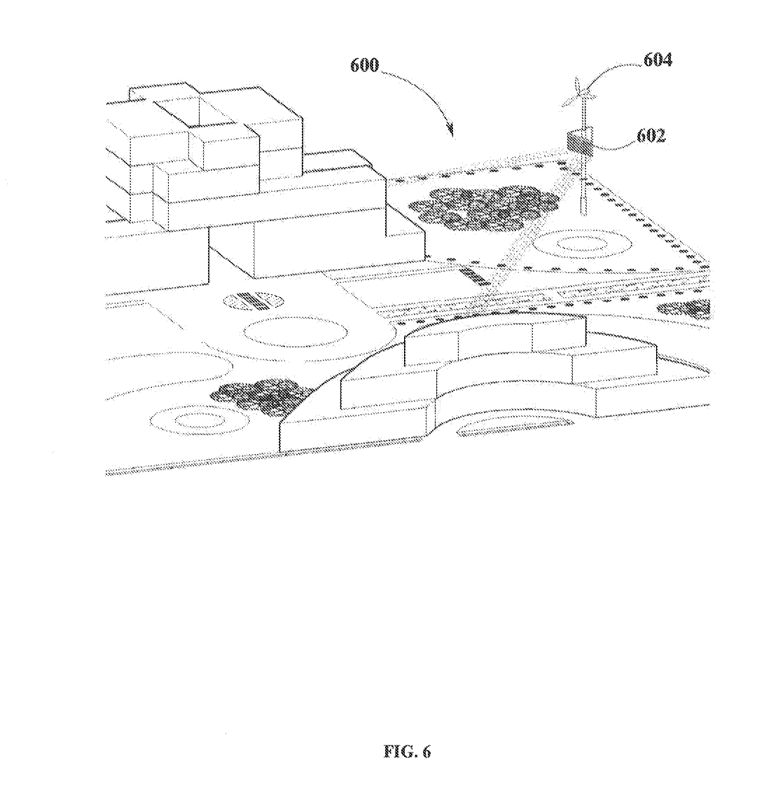

FIG. 5 illustrates a WPT 500 where either one or a plurality of transmitters 502 can be used to provide wireless power, through pocket-forming, to pedestrians wanting to charge electronic devices. As in the previous embodiment from FIG. 4, transmitter 502 can utilize solar panels 504 as power supply 214. In addition, transmitter 502 and solar panel 504 can be placed in lamp pole structures and can be seen as mainstream infrastructure. Solar panels 504 for this application can be from about 10 feet to about 30 feet in size. In this embodiment, pedestrians may charge their electronic devices, which may operatively be coupled to, attached to or otherwise include receivers suitable for pocket forming, while walking on the street on their way to work or while enjoying foods or beverages in food carts and the like. WPT 500 can be used whenever a lamp pole structure can be placed, for example in parks, bridges and the like. In other variations of WPT 500, pedestrians may charge portable rechargeable batteries 506 which upon charging may be utilized at their homes or work sites. This foregoing embodiment may be beneficial for regions where electricity may be scarce, for example, in villages or in third world contexts. Moreover, electric companies can set up dedicated stations for powering such batteries 506 and may charge a fee based on the amount of power requested. WPT 500 may lead to spreading green infrastructures for power handling and distribution. Such an example can be seen in FIG. 6 below.

FIG. 6 illustrates a WPT 600 where a transmitter 602 may utilize a typical wind turbine 604 as power supply 214. By using the power of the wind and the components typically associated with wind turbine 604, power can be delivered wirelessly, through transmitter 602 and pocket-forming, to houses or dedicated regions without utilizing wires, thereby reducing the cost associated with the distribution of energy. In addition, wireless power can be used by any user in the region utilizing a pocket-forming enabled device, i.e. utilizing devices which may operatively be coupled to, attached to or otherwise include receivers suitable for pocket forming.

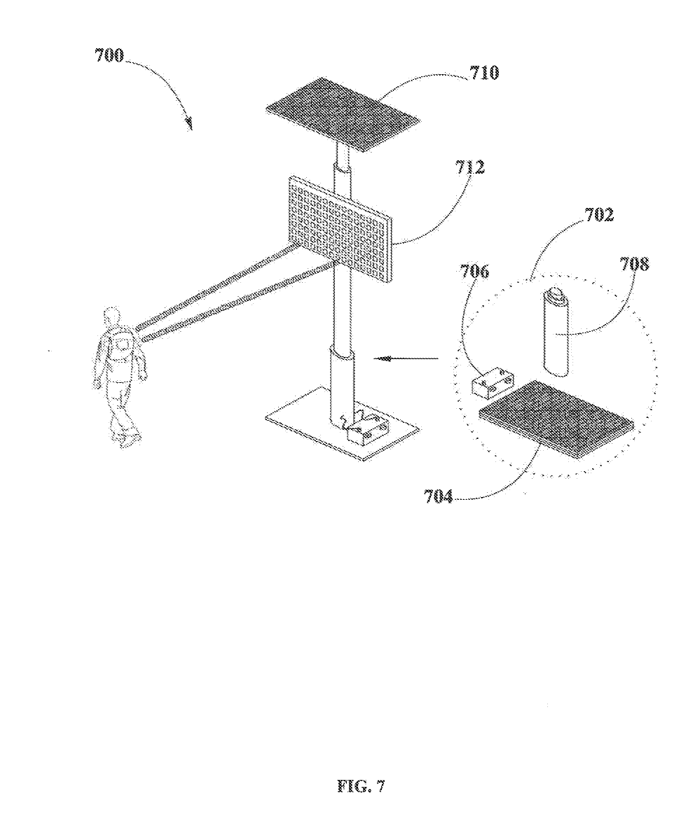

FIG. 7 illustrates a WPT 700 where a portable assembly 702 for delivering power wirelessly may be utilized. Assembly 702, located at the rightmost part of FIG. 7, may include a power module 704 which may further include a power source and a transmitter (not shown), a battery component 706 for storing surplus energy and a collapsible pole structure 708 for mounting the aforementioned components. Pole structure 708 can be made of a suitable material, for example aluminum, which provides high strength, durability and low weight. Pole structure 708 when extended can be of about 10 to 30 feet in height. In its top part, a power source, such as a solar panel 710 (included in module 704) may be placed. Then, a transmitter 712 (also from module 704) may be attached to pole structure 708 by suitable mechanical means such as brackets, fasteners and the like. Moreover, transmitter 712 may electrically be connected to solar panel 710 to utilize solar energy for providing wireless power. Lastly, battery component 706 may also be connected to store surplus energy which can be used to provide power during the night, or during poor solar conditions. Finished Assembly 702 can be seen in the leftmost part of FIG. 7. This configuration for WPT 700 can be beneficial when users requiring power find themselves in areas where electricity may be scarce, for example in villages in the third world, in jungles, deserts, while navigating in the ocean, or any other situation or location where power may not be accessible.

While various aspects and embodiments have been disclosed herein, other aspects and embodiments are contemplated. The various aspects and embodiments disclosed herein are for purposes of illustration and are not intended to be limiting, with the true scope and spirit being indicated by the following claims.

Having thus described the invention, I claim:

1. A method for a wireless power transmission, comprising the steps of:
transmitting controlled radio frequency waves from a pocket-forming transmitter to converge pockets of energy in 3-d space for powering a portable electronic device;
connecting an alternate energy source to the pocket-forming transmitter to provide a power source for the transmitter; and
capturing the pockets of energy by a receiver to charge or power the electronic device connected to the receiver.

2. The method for a wireless power transmission of claim 1, wherein the alternate energy source is at least one solar panel or at least one wind turbine for the power source.

3. The method for a wireless power transmission of claim 2, wherein the pocket-forming transmitter includes a housing suitable for a field use, at least two or more antenna elements, at least one RF integrated circuit, at least one digital signal processor, at least one communication component and at least one battery component to store surplus energy generated by the power source.

4. The method for a wireless power transmission of claim 3, wherein the receiver is embedded in the electronic device and further includes a housing, at least one antenna element, at least one rectifier, at least one power converter and at least one communication component to establish communication with the transmitter or other electronic equipment for continuing to receive pockets of energy from the pocket-forming transmitter whenever the electronic device is within a predetermined distance from the transmitter.

5. The method for a wireless power transmission of claim 2, further including the step of extending the transmission distance of the pocket-forming transmitter by mounting the pocket-forming transmitter and solar panel on a roof of a building or a lamp pole located in a place accessible to the public.

6. The method for a wireless power transmission of claim 5, wherein the place is an airport, bus station, train station, a stadium, an amusement park, a city park, an outdoor pool or a public beach.

7. The method for a wireless power transmission of claim 4, wherein the receiver communicates with the transmitter by short RF signals sent through the antenna elements of the receiver and transmitter.

8. The method for a wireless power transmission of claim 6, wherein the short RF signals are standard wireless communication protocols including Bluetooth, Wi-Fi, ZigBee or FM radio.

9. The method for a wireless power transmission of claim 4, further includes the step of utilizing adaptive pocket-forming to regulate the pockets of energy transmitted by the transmitter to power the electronic device in range of the transmitter.

10. The method for a wireless power transmission of claim 1, further including the step of coupling the transmitter of a predetermined size to the alternative power source wherein the alternate power source is a solar panel of a predetermined size mounted on a pole along with the transmitter whereby pedestrians passing within range of the transmitter are charging the electronic device.

11. The method for a wireless power transmission of claim 3, wherein the stored surplus energy in the battery is used to power the transmitter during the night or during poor solar or wind conditions.

12. A wireless power transmission, comprising:
a pocket-forming transmitter for generating power RF waves to form pockets of energy converging in 3-d space for powering or charging an electronic device;
an alternative power source connected to the transmitter for powering the transmitter; and
a receiver fur capturing the pockets of energy to charge or power the electronic device connected to the receiver.

13. The wireless power transmission of claim 12, wherein the alternative power source is a solar panel or a wind turbine.

14. The wireless power transmission of claim 13, wherein the pocket-forming transmitter includes a battery for storage of surplus energy developed by the alternative power source for powering the transmitter in poor solar and wind conditions.

15. The wireless power transmission of claim 14, further includes a pole extendible to a predetermined height for mounting the pocket-forming transmitter and solar panel or wind turbine thereon to transmit pockets of energy to the receivers of the electronic device for charging and powering the electronic devices held by pedestrians in places open to the public.

16. The wireless power transmission of claim 13, wherein the pocket-forming transmitter and alternative power source are mounted on roofs of buildings to transmit the pockets of energy for powering or charging the electronic device.

17. The wireless power transmission of claim 12, wherein the transmitter and receiver both include a communication component and antenna elements for communication between the transmitter and receiver through short RF signals over standard wireless communication protocols including Bluetooth, Wi-Fi, ZigBee or FM radio.

18. A wireless power transmission, comprising:
a pocket-forming transmitter for transmitting power RF waves to form pockets of energy to charge an electronic device;
an alternative power source coupled to the transmitter for powering the pocket-forming transmitter;
a battery for storing surplus energy from the alternative power source connected to the transmitter for powering the transmitter during down times of the alternative power source; and
a receiver connected to the electronic device for capturing the pockets of energy to charge or power the electronic device when the alternative power source is actively producing power.

19. The wireless power transmission of claim 18, wherein the pocket-forming transmitter is electrically connected to a solar panel or wind turbine to generate power to run the transmitter when solar energy or wind energy are available and further including a battery for capturing the surplus energy from the solar panel or wind turbine for powering the transmitter whenever solar or wind energy are unavailable due to weather conditions.

20. The wireless power transmission of claim 19, wherein the solar panel or wind turbine and the transmitter connected thereto are mounted on a pole of a predetermined height to supply power to receivers embedded in the electronic device for meeting power requirements in third world villages, jungles, deserts and other locations without power accessibility.
